(19) United States
(12) Patent Application Publication
(10) Pub. No.: US 2005/0288176 A1
(43) Pub. Date: Dec. 29, 2005

(54) Delayed action catalysts and methods for polymerizing macrocyclic oligomers

(76) Inventors: Roger Lewis Kuhlman, Lake Jackson, TX (US); Robert Louis Sammler, Midland, MI (US); Francis J. Timmers, Midland, MI (US)

Correspondence Address: GARY C. COHN, PLLC, 1147 NORTH FOURTH STREET, UNIT 6E, PHILADELPHIA, PA, 19123, US

(21) Appl. No.: 11/154,015

(22) Filed: Jun. 16, 2005

Related U.S. Application Data
(60) Provisional application No. 60/581,186, filed on Jun. 18, 2004.

(51) Int. Cl. B01J 21/00

(52) U.S. Cl. 502/100

(57) ABSTRACT

Cyclic oligomers containing ester linkages are polymerized in the presence of a dialkyltin di(carboxylate) catalyst. The catalyst provides a latency period followed by a rapid polymerization to form a high molecular weight polymer.

### CROSS-REFERENCE TO RELATED APPLICATION

This application claims benefit of U.S. Provisional Application 60/581,186, filed Jun. 18, 2004.

### BACKGROUND OF THE INVENTION

This invention relates to methods for forming polyesters and polyester copolymers from cyclic oligomeric esters.

The ring-opening polymerization of cyclic oligomers containing ester linkages is a convenient way of preparing high molecular weight polyesters. Although polyesters are thermoplastics, and can be melt processed as high molecular weight polymers, the polymerization of the cyclic oligomers offers the possibility of conducting molding or other melt processing operations simultaneously with the polymerization. The oligomers melt to form relatively low viscosity fluids that can be easily pumped and/or used to impregnate a variety of reinforcing materials. Therefore, using cyclic oligomers provides a means by which a high molecular weight thermoplastic polymer can be processed much like many thermosetting polymer systems.

The ring-opening polymerization is conducted in the presence of a catalyst in order to obtain commercially reasonable cycle times. A variety of tin, titanium and other metal compounds have been used. Active catalysts that provide rapid polymerization rates tend to have short induction periods. This can be a disadvantage under some circumstances. For example, in casting operations, or operations involving molding large parts, it is often helpful to have a latent period before polymerization and consequent viscosity build-up begins. Even simple production of a formulated cyclic oligomer/catalyst mixture requires heating the cyclic oligomer above its melting temperature, at which temperatures polymerization can occur once the catalyst and oligomer are combined. Catalyst latency would create a reasonable time window to make the formulated mixture without significant premature polymerization taking place. Very inefficient catalysts in effect provide such a window, but they also tend to need long polymerization times in order to build molecular weight. What is desired is a catalyst that exhibits a latency period but which thereafter provides for a rapid polymerization rate to form a high molecular weight polymer.

### SUMMARY OF THE INVENTION

In one aspect, this invention is a process for polymerizing a macrocyclic oligomer, comprising heating the macrocyclic oligomer to a temperature sufficient to melt the macrocyclic oligomer in the presence of a polymerization catalyst for the macrocyclic oligomer, wherein the polymerization catalyst is a diorganotin dicarboxylate.

The polymerization catalysts used in this invention provide a latency period, typically on the order of tens of minutes in duration, after which they actively and rapidly catalyze the polymerization of the macrocyclic oligomer to a high molecular weight polymer. Little polymerization (as evidenced by increases in viscosity) occurs during the latency period. On the other hand, polymerization rates after onset of rapid polymerization often closely approach those obtained using conventional tin catalysts such as di-n-butyltin glycolate.

### DETAILED DESCRIPTION OF THE INVENTION

The polymerization catalyst used herein is a diorganotin di(carboxylate). The catalyst can be represented by the structures I and II:
R₂—Sn—[OC(O)R¹]₂ (I)
and 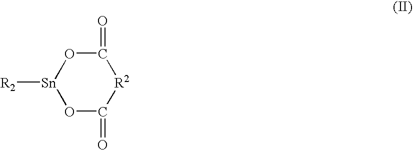
where each R is independently a substituted or unsubstituted hydrocarbyl group, and each R¹ is independently a substituted or unsubstituted hydrocarbyl group, and R² is a covalent bond or a substituted or unsubstituted divalent hydrocarbyl group. The two R groups may together form a single divalent group that forms a ring including the tin atom.

The R groups are suitably straight-chained or branched alkyl or aryl groups having from about 1 to about 20, preferably from about 2 to about 12 and especially from about 3 to about 8 carbon atoms. The R groups are bonded to the tin atom through a carbon atom on the R group. The R groups may contain one or more substituents that do not react with the macrocyclic oligomer and do not undesirably affect catalytic activity. Such substituents may include sites of carbon-carbon unsaturation, ether groups, hydroxyl groups, halogens and the like. Preferred R groups are hydrocarbyl. Suitable R groups include alkyl groups such as ethyl, n-propyl, isopropyl, n-butyl, isobutyl, t-butyl, n-hexyl, isohexyl, isooctyl, n-octyl, isodecyl and n-decyl groups, phenyl, benzyl, alkyl-substituted phenyl, naphthyl, and the like. n- and t-butyl groups are of particular interest.

The R groups may together form a divalent radical such as —CH₂—CH₂—, —CH₂—CH(R³)—, and —CH₂CH₂—O—CH₂—CH₂—, where R³ is alkyl of 1-4 carbon atoms.

The R¹ groups are suitably alkyl, aryl, cycloalkyl or like hydrocarbyl groups, generally containing from about 1 to about 24, especially about 2 to about 12 carbon atoms. The R¹ groups may be linear, cyclic or branched. The R¹ groups may be unsubstituted or contain substituents that do not react with the macrocyclic oligomer and do not undesirably affect catalytic activity

Preferred R² groups are a covalent bond or a divalent, straight or branched chain hydrocarbyl group or ether group containing from about 1 to about 12, especially from 2 to 4 carbon atoms. Particularly noteworthy are —CH═CH—, —CH₂—CH₂—, —CH₂—CH(R³)—, and —CH₂CH₂—O—CH₂—CH₂— groups, where R³ is alkyl of 1-4 carbon atoms.

Catalysts represented by structures I and II represent empirical structures. Actual catalysts may exist in dimer, trimer or other oligomeric forms.

Specific examples of suitable catalysts include dibutyltinoxalate, dibutyltinmaleate, dibutyltinphthalate, dibutyltindi(2-ethyl hexanoate), and the like.

These catalysts are conveniently prepared by reacting a tin oxide of the general structure R₂Sn═O with a carboxylic acid (or corresponding acid halide or lower alkyl ester), i.e., a carboxylic acid having the structure HOC(O)R¹ or a diacid having the form HOC(O)R²C(O)OH.

The cyclic oligomer is a polymerizable cyclic material having two or more ester linkages in a ring structure. The ring structure containing the ester linkages includes at least 8 atoms that are bonded together to form the ring. The oligomer includes two or more structural repeat units that are connected through the ester linkages. The structural repeat units may be the same or different. The number of repeat units in the oligomer suitably ranges from about 2 to about 8. Commonly, the cyclic oligomer will include a mixture of materials having varying numbers of repeat units. A preferred class of cyclic oligomers is represented by structure III
—[O-A-O—C(O)—B—C(O)]_{y}— (III)
where A is a divalent alkyl, divalent cycloalkyl or divalent mono- or polyoxyalkylene group, B is a divalent aromatic or divalent alicyclic group, and y is a number from 2 to 8. The bonds indicated at the ends of structure III connect to form a ring. Examples of suitable macrocyclic oligomers corresponding to structure III include oligomers of 1,4-butylene terephthalate, 1,3-propylene terephthalate, 1,4-cyclohexenedimethylene terephthalate, ethylene terephthalate, and 1,2-ethylene-2,6-naphthalenedicarboxylate, and copolyester oligomers comprising two or more of these. The macrocyclic oligomer is preferably one having a melting temperature of below about 200° C. and preferably in the range of about 150-190° C. A particularly preferred cyclic oligomer is a 1,4-butylene terephthalate oligomer.

Suitable methods of preparing the cyclic oligomer are described in U.S. Pat. Nos. 5,039,783, 6,369,157 and 6,525,164, WO 02/18476 and WO 03/031059, all incorporated herein by reference. In general, cyclic oligomers are suitably prepared by reaction of a diol with a diacid, diacid chloride or diester, or by depolymerization of a linear polyester. The method of preparing the cyclic oligomer is generally not critical to this invention.

Similarly, methods of polymerizing cyclic oligomers are well known. Examples of such methods are described in U.S. Pat. Nos. 6,369,157 and 6,420,048, WO 03/080705 and U.S. Published application 2004/0011992, among many others. Any of these conventional polymerization methods are suitable for use with this invention, the methods being modified in that the polymerization is conducted in the presence of the polymerization catalyst described above.

The polymerization may be conducted neat (i.e., solventless) or in the presence of a solvent.

In general, the polymerization is conducted by heating the cyclic oligomer above its melting temperature in the presence of an effective amount of the catalyst. The polymerizing mixture is maintained at the elevated temperature until the desired molecular weight and conversion is obtained. Suitable polymerization temperatures are from about 100° C. to about 300° C., with a temperature range of about 100° C. to about 280° C. being preferable and a temperature range of about 180-270° C. being especially preferred.

The catalyst is advantageously used in amount of about 0.0001 to about 0.05 mole of catalyst per mole of cyclic oligomer. The catalyst may be used in an amount of about 0.0005 to about 0.01 mole/mole of cyclic oligomer. A particularly useful amount of catalyst is from about 0.001 to about 0.006 mole/mole of cyclic oligomer. Amounts may vary somewhat depending on the activity of the particular catalyst and the desired rate of reaction.

The polymerization may be conducted in a closed mold to form a molded article. An advantage of cyclic oligomer polymerization processes is that they allow thermoplastic resin molding operations to be conducted using techniques that are generally applicable to thermosetting resins. When melted, the cyclic oligomer typically has a relatively low viscosity. This allows the cyclic oligomer to be used in reactive molding process such as liquid resin molding, reaction injection molding and resin transfer molding, as well as in processes such as resin film infusion, impregnation of fiber mats or fabrics, prepreg formation, pultrusion and filament winding that require the resin to penetrate between individual fibers of fiber bundles to form structural composites. Certain processes of these types are described in U.S. Pat. No. 6,420,047, incorporated herein by reference.

The resulting polymer must achieve a temperature at which it solidifies before it is demolded. Thus, it may be necessary to cool the polymer before demolding (or otherwise completing processing). In some instances, particularly in polymerizing butylene terephthalate oligomers, the melting and polymerization temperature of the oligomers is below the crystallization temperature of the resulting polymer. In such a case, the polymerization temperature is advantageously between the melting temperature of the oligomer and the crystallization temperature of the polymer. This allows the polymer to crystallize at the polymerization temperature (isothermal curing) as molecular weight increases. In such cases, it is not necessary to cool the polymer before demolding can occur.

A problem with conventional catalysts for cyclic oligomer polymerization processes is premature polymerization. Because the cyclic oligomers are solids at room temperatures, it is necessary to heat them above the melting temperature in order to use them in many molding and impregnation processes. It is convenient to maintain a vessel of molten oligomer, which is readily transferred as a liquid to the mold or impregnation line. Preheating reduces cycle times and thus improves the efficiency of the process. However, if the molten oligomer is in the presence of catalyst, polymerization can occur in the holding vessel or transfer lines. This can lead to undesirable viscosity increases or even premature set-up. An advantage of this invention is that these catalysts exhibit a sufficiently long latency period, during which little or no polymerization occurs, such that viscosity build-up is delayed and longer operating windows are provided.

Copolyesters can be prepared by polymerizing the cyclic oligomer and one or more copolymerizable monomers. Such copolymers can be random copolymers, which are prepared by reacting a mixture of cyclic oligomer and comonomer. The copolymers can also be block copolymers, which are conveniently prepared by sequentially introducing the cyclic oligomer and comonomer to the polymerization. Suitable copolymerizable monomers include cyclic esters such as lactones. The lactone conveniently contains a 4-7 member ring containing one or more ester linkages. The lactone may be substituted or unsubstituted. Suitable substituent groups include halogen, alkyl, aryl, alkoxyl, cyano, ether, sulfide or tertiary amine groups. Substituent groups preferably are not reactive with an ester group so as to function as an initiator compound. Examples of such copolymerizable monomers include glycolide, dioxanone, 1,4-dioxane-2,3-dione, ε-caprolactone, tetramethyl glycolide, β-butyrolactone, lactide, γ-butyrolactone and pivalolactone. In addition, polymeric diol materials such as polyether diols and polyester diols may be incorporated into the cyclic oligomer mixture to form block copolymers.

Various kinds of optional materials may be incorporated into the polymerization process. Examples of such materials include fillers, nanofillers, reinforcing agents (such as glass, carbon or other fibers), flame retardants, colorants, antioxidants, preservatives, mold release agents, lubricants, UV stabilizers, and the like.

The following examples are provided to illustrate the invention, but are not intended to limit the scope thereof. All parts and percentages are by weight unless otherwise indicated.

### EXAMPLE 1 AND COMPARATIVE EXPERIMENT A

Di-n-butylstannoxide (8 g, 32 mmol) is charged to a 3-necked one liter roundbottom flask, together with 4.05 g oxalic acid and 450 mL toluene. An overhead stirrer and Dean-Stark condenser are attached, and the mixture heated to reflux for one hour. The condenser is then replaced by a modified condenser with a return arm containing molecular sieves. Reflux is continued for a second hour, after which the sieves are replaced with fresh sieves and another hour of refluxing is performed. The mixture is cooled and the product collected by filtration. About 10.1 g of dibutyltinoxalate is obtained.

Cyclic butylene terephthalate oligomers are dried under vacuum at 100° C. for six hours. Three grams of the dried oligomers are combined with 13 milligrams of the dibutyltinoxalate catalyst, by mixing the respective solid materials and shaking.

The activity of the catalyst in polymerizing cyclic butylene terephthalate oligomers is evaluated by following the viscosity as a function of time in an oligomer/catalyst mixture maintained under polymerization conditions. Polymerizations are conducted under a nitrogen atmosphere in an Advanced Rheometric Expansion System (Rheometric Scientific) dynamic mechanical spectrometer using RSI Orchestrator software. The device is equipped with custom-made aluminum cup-and-plate fixtures. The diameters of the cup and plate are 25 and 7.9 mm, respectively. Approximately 3 g of dried cyclic butylene terephthalate oligomer/catalyst mixture is charged into the cup, which is preheated to ˜160° C. The plate is lowered into the cup to contact the surface of the oligomer, and the distance between the cup and plate is measured. The oligomers are permitted to melt at 160° C., and then the temperature of the plate and cup are warmed rapidly to 190° C., and equilibrated and held at 190° C. to monitor the polymerization of the oligomers.

Low-strain amplitude oscillations are imposed on the contents of the cup via an actuator attached to the cup. The actuator forces the cup to oscillate sinusoidally in a twisting motion about the vertical axis. Some of this energy is transmitted to the plate through the sample, causing the plate to twist sinusoidally. The complex shear viscosity η* of the sample is estimated from the amplitude of the cup angular displacement, the amplitude of the torque on the plate, the phase lag of the plate relative to the cup, the angular frequency of the sinusoidal signals, and the sample dimensions. The magnitude |η*| of the complex shear viscosity is a key metric of the progress of the polymerization, and is henceforth simply referred to as the viscosity. This method provides good estimates of viscosity increases from about 20 poises to somewhat in excess of about 10,000 poises, and allows the progress of the polymerization to be followed.

Viscosity is followed as a function of time while maintaining the temperature at 190° C.

For comparison, the same experiment is repeated with a mixture of three grams of the cyclic butylene terephthalate and 12 milligrams of di-n-butyltinethylene glycolate as catalyst (Comparative Experiment A).

In Comparative Experiment A, the onset of polymerization, as indicated by a measurable viscosity increase, is less than one minute. Rapid viscosity buildup is seen immediately after the onset of polymerization. The sample with di-n-butyltinoxalate catalyst exhibits no measurable viscosity increase for 60-70 minutes, after which a rapid polymerization occurs at a rate somewhat more slowly than seen with Comparative Sample A.

### EXAMPLE 2

Di-n-butylstannoxide (8 g, 32 mmol) is charged to as 3-necked one liter roundbottom flask, together with 10.7 g phthalic acid and 450 mL toluene. The mixture is treated as in Example 1 to give 20 g of material containing a crude di-n-butyltinphthalate.

The activity of the crude di-n-butytinphthalate catalyst in polymerizing cyclic butylene terephthalate oligomers is evaluated as in Example 1, using 2.973 g of oligomer and 15.6 mg of catalyst. The sample with di-n-butyltinphthalate catalyst exhibits no measurable viscosity increase for 10-12 minutes, after which a polymerization occurs at a rate slower than that seen with Comparative Experiment A.

### EXAMPLE 3

The activity of di-n-butytinmaleate as a catalyst for polymerizing cyclic butylene terephthalate oligomers is evaluated as in Example 1, using 3.0 g of oligomer and 14.2 mg of catalyst. The sample with di-n-butyltinmaleate catalyst exhibits no measurable viscosity increase for 1-2 minutes, after which a polymerization occurs at a rate slower than that seen with Comparative Experiment A.

### EXAMPLE 4

The activity of di-n-butytindi(2-ethylhexanoate) as a catalyst in polymerizing cyclic butylene terephthalate oligomers is evaluated as in Example 1, using 3.0 g of oligomer and 21.2 mg of catalyst. The sample with di-n-butyltindi(2-ethylhexanote) catalyst exhibits no measurable viscosity increase for 2 minutes, after which a polymerization occurs at a rate slower than that seen with Comparative Experiment A.

It will be appreciated that many modifications can be made to the invention as described herein without departing from the spirit of the invention, the scope of which is defined by the appended claims.

1. A process for polymerizing a macrocyclic oligomer, comprising heating the macrocyclic oligomer to a temperature sufficient to melt the macrocyclic oligomer in the presence of a polymerization catalyst for the macrocyclic oligomer, wherein the polymerization catalyst is a diorganotin dicarboxylate.

2. The process of claim 1, wherein the polymerization catalyst has structure I or structure II, wherein structure I is:
R₂—Sn—[OC(O)R¹]₂ (I)
where each R is independently an alkyl group or where the R groups together constitute a single divalent group that forms a ring including the tin atom, and each R¹ is independently a substituted or unsubstituted hydrocarbyl group, and structure II is: 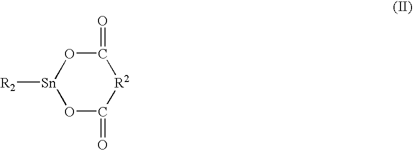
where each R is independently an alkyl group or where the R groups together constitute a single divalent group that forms a ring including the tin atom and R² is a covalent bond or a substituted or unsubstituted divalent hydrocarbyl group.

3. The process of claim 2, wherein each R group is independently a straight-chained or branched alkyl group having from about 1 to about 20 carbon atoms.

4. The process of claim 3, wherein each R group is independently an ethyl, n-propyl, isopropyl, n-butyl, isobutyl, t-butyl, n-hexyl, isohexyl, isooctyl, n-octyl, isodecyl or n-decyl group.

5. The process of claim 4, wherein each R group is an n-butyl or a t-butyl group.

6. The process of claim 2, wherein the polymerization catalyst has structure I and each R¹ group is independently a substituted or unsubstituted alkyl, aryl, cycloalkyl or other hydrocarbyl group containing from about 2 to about 24 carbon atoms.

7. The process of claim 2, wherein the polymerization catalyst has structure II and each R² group is independently a divalent, straight or branched chain hydrocarbyl group or ether group containing from about 1 to about 12 carbon atoms.

8. The process of claim 7, wherein the R² groups are each —CH₂—CH₂—, —CH₂—CH(R³) —, or —CH₂CH₂—O—CH₂—CH₂, where R³is an alkyl group containing 1-4 carbon atoms.

9. The process of claim 1 wherein the catalyst is di-n-butyl tin oxalate.

10. The process of claim 1, wherein the cyclic oligomer is a cyclic 1,4-butylene terephthalate.

11. The process of claim 2, wherein the cyclic oligomer is a cyclic 1,4-butylene terephthalate.

12. The process of claim 6, wherein the cyclic oligomer is a cyclic 1,4-butylene terephthalate.

13. The process of claim 7, wherein the cyclic oligomer is a cyclic 1,4-butylene terephthalate.

14. The process of claim 9, wherein the cyclic oligomer is a cyclic 1,4-butylene terephthalate.
